(19) United States
(12) Patent Application Publication
(10) Pub. No.: US 2004/0054599 A1
(43) Pub. Date: Mar. 18, 2004

(54) Network-based system and method for picking final recipients of joint-purchase goods through games

(76) Inventor: Jin Tae Kim, Seoul (KR)

Correspondence Address: Ladas & Parry, 26 West 61st Street, New York, NY, 10023, US

(21) Appl. No.: 10/269,638

(22) Filed: Oct. 11, 2002

(30) Foreign Application Priority Data
Sep. 17, 2002 (KR) P 2002-56554

(51) Int. Cl. G06F 17/60

(52) U.S. Cl. 705/26

(57) ABSTRACT

Disclosed is related to network-based system and method for picking final recipients of joint-purchase goods through games, which register in a server computer joint-purchase goods based on information on various goods provided from plural goods provider computers, log in new member registrations and members of user computers connected for communications and output information on plural joint-purchase goods registered in a database at present, pay for joint-purchases of corresponding joint-purchase goods inputted from the user computers, automatically generate game matches for selecting final recipients from all the users participating in joint purchases of corresponding joint-purchase goods if participation periods of time for the specified joint-purchase goods expire or the number of participants noticed in advance is reached, proceed with games for picking final recipients of the respective user computers based on the automatically generated game matches, output to the goods provider computers information on final recipients picked based on game progresses and deliver corresponding joint-purchase goods to final recipients.

Accordingly, the present invention enables users to obtain opportunities acquiring at low prices goods purchased through users' joint payments so as to greatly increase funs and interest in electronic commerce, and there is an effect in that goods retailers or service operators can greatly improve profits through electronic commerce activations of users.

### BACKGROUND OF THE INVENTION

1. Field of the Invention

The present invention relates to system and method for picking final recipients of joint-purchase goods, and more particularly to network-based system and method for picking final recipients of joint-purchase goods through games wherein plural on-line users jointly pay for goods to purchase the goods and pick recipients to finally receive the jointly purchased goods through games.

2. Description of Prior Art

The internet is generally an open-type network any one in anywhere in the world can freely connect, for use, to his intended counterpart computers with an application of the common protocol of TCP/IP(Transmission Control Protocol/Internet Protocol), which can be used to transfer basic text information as well as multimedia information together with developments of compression technologies, and used for a variety of services such as electronic mails, file transfers, World Wide Web(WWW), and so on.

Together with the rapid increase of such internet uses in domestic and worldwide, the internet rapidly adds its importance thereto as a strategic tool for reconsidering efficiency and productivity over all sectors of existing industries, continuously creating new business opportunities therethrough, and the trend expanding the areas to which the internet is applied gradually increases businessmen using the internet.

That is, in line of businesses through the internet, sites are being rapidly increased that provide a variety of contents such as internet ads, internet broadcasts, on-line games, internet newspapers/journals, search services, portal services, electronic commerce, and so on.

Of the sites as above, sites related to electronic commerce are largely increased together with active on-line goods trades in recent, and it is the trend that users use the electronic commerce sites more due to the advantages that they can conveniently and comfortably purchase desired goods on-line instead of directly dropping by market places.

Together with the gradual increase of electronic commerce scale as such, electronic commerce sites are exerting effort to develop differentiated services that are not provided by other counterpart sites in order for users to visit their sites more than others.

That is, differentiated sales methods are introduced such as joint-purchase services lowering goods prices through massive purchases which enables users in electronic commerce to buy goods at low prices, lowest price services selling the same goods at lowest prices than other counterpart electronic commerce sites, or the like.

However, the joint-purchase or lowest price services as stated above, which are used in most electronic commerce sites, make sales profits of sites worse as lowering sales prices, so there exists a problem that big difficulties are brought about in running sites due to excessive competitions among electronic commerce sites.

Accordingly, in order to overcome the above problems, electronic commerce sites offer certain premiums to users making a purchase of over a certain amount, breaking the convention of trading goods simply, or make funs and interest for users in electronic commerce by providing extra services such as games and the like, so that they can improve profits and increase site recognitions of users through electronic commerce activations.

However, the premiums offerings or extra services such as games as stated above have limitations in providing funs and interest to users who use the electronic commerce as well as a problem that profits are not greatly improved.

### SUMMARY OF THE INVENTION

Accordingly, in order to solve the above problems, it is an object of the present invention to provide network-based system and method for picking final recipients of joint-purchase goods through games wherein plural on-line users jointly pay for, purchase specified goods, and pick final recipients of the joint-purchase goods through games.

It is another object of the present invention to provide network-based system and method for picking final recipients of joint-purchase goods through games wherein users collectively play games for picking final recipients of joint-purchase goods at times designated in advance.

It is yet anther object of the present invention to provide network-based system and method for picking final recipients of joint-purchase goods through games wherein users play games for picking final recipients of joint-purchase goods in a one-to-one tournament fashion.

It is a further object of the present invention to provide network-based system and method for picking final recipients of joint-purchase goods through games wherein site operators can adjust the participation number and payments of users who jointly pay for specified goods to increase and lower the odds in picking final recipients of the goods.

In order to achieve the above objects, a network-based system for picking final recipients of joint-purchase goods through games according to the present invention comprises a communication network for connecting plural unspecified communication lines to communicate data therebetween; plural user computers for inputting information on plural joint-purchase goods from a server computer connected through the communication network wherein the information further includes participation periods of time, the number of participants, joint-purchase amounts, and participants status, outputting to the server computer joint-purchase request data of specified goods selected by users who have identified the information on the plural joint-purchase goods, outputting to the server computer payment data of corresponding joint-purchase goods inputted by the users based on payment requests of the server computer, and connecting for communications to the server computer according to users' manipulations and participating in games for picking final recipients of the corresponding joint-purchase goods after participation periods of time for specified joint-purchase goods expire or the number of participants noticed in advance is reached; plural goods provider computers for outputting to the server computer detailed information on various goods in stock for goods sales requests and controlling deliveries of corresponding joint-purchase goods based on information on final recipients inputted from the server computer; and the server computer for registering joint-purchase goods in order for users to jointly pay for purchases based on information on various goods requested for sales from the plural goods provider computers, outputting plural joint-purchase goods to the plural user computers connected for communications through the communication network wherein the information further includes participation periods of time, joint-purchase amounts, and participants status, requesting for payments for joint purchases of goods if joint-purchase request data for corresponding goods is inputted from the user computers, paying for joint-purchase goods based on payment data inputted from corresponding user computers, automatically generating game matches for picking final recipients from all users participating in joint-purchase goods if participation periods of time expire or the number of participants noticed in advance is reached, proceeding with games for selecting winners of the respective user computers connected through the communication network till final recipients are picked based on the automatically generated game matches, and, if final recipients are selected according to game progresses, outputting information on corresponding final recipients to goods provider computers and ordering deliveries of corresponding joint-purchase goods.

Further, a network-based method for picking final recipients of joint-purchase goods through games comprises steps of (1) registering, in a server computer, joint-purchase goods for which plural users jointly pay for purchases and select final recipients through games, based on information on various goods inputted from plural goods provider computers connected for communications through a communication network; (2) carrying out, in the server computer, new member registrations or members logs-in of user computers connected for communications through the communication network, and outputting to corresponding user computers information on plural joint-purchase goods wherein the information further includes participation periods of time, the number of participants, joint-purchase amounts, and participants status which are registered in a database at is present; (3) paying for joint-purchases of corresponding goods according to joint-purchase request data of specified goods inputted from the user computers which have identified information on plural joint-purchase goods, and updating and storing joint-purchase participants status of corresponding goods; (4) automatically generating, in the server computer, game matches for selecting final recipients from all users participating in joint purchases of corresponding goods if participation periods of time for specified joint-purchase goods expire or the number of participants noticed in advance is reached, and proceeding with games for picking final recipients of the respective user computers connected for communications through the communication network based on the automatically generated game matches; and (5) outputting information on final recipients selected based on game progresses from the server computer to the goods provider computers and controlling deliveries of corresponding joint-purchase goods to final recipients.

### BRIEF DESCRIPTION OF THE DRAWINGS

The above objects and other features of the present invention will become more apparent by describing in detail a preferred embodiment thereof with reference to the attached drawings, in which:

FIG. 1 is a block diagram for schematically showing a structure of a network-based system for picking final recipients of joint-purchase goods through games according to an embodiment of the present invention;

FIG. 2 is a block diagram for showing in detail a structure of the server computer of FIG. 1;

FIG. 3 is a flow chart for showing in detail an operation process for a network-based method for picking final recipients of joint-purchase goods through games; and

FIG. 4 to FIG. 8 are flow charts for showing in detail operation procedures for the respective subroutines of FIG. 3.

### DETAILED DESCRIPTION OF THE PREFERRED EMBODIMENT

Hereinafter, a description is made in detail on network-based system and method for picking final recipients of joint-purchase goods through games with reference to the accompanying drawings.

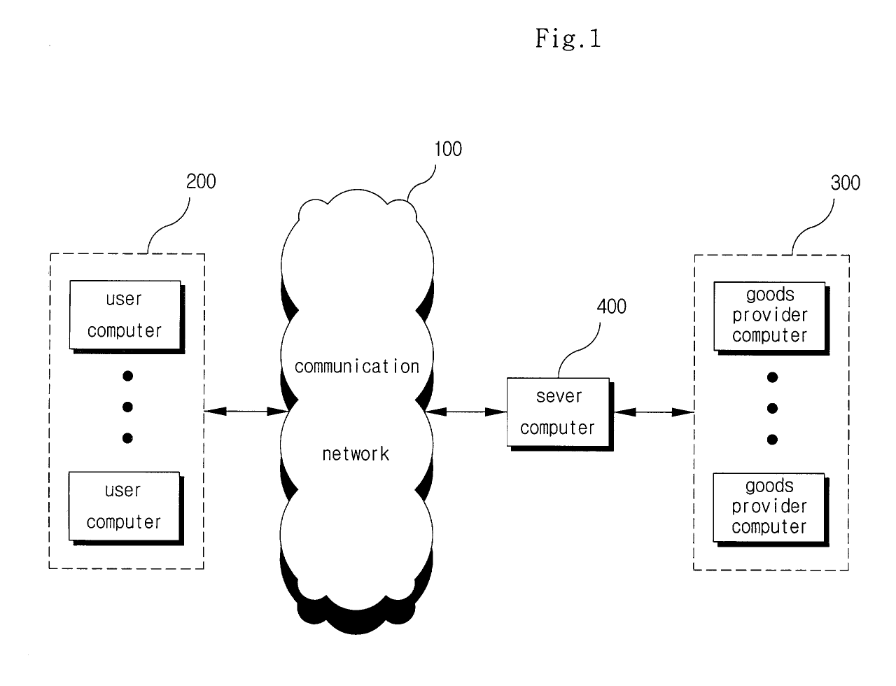

FIG. 1 is a block diagram for schematically showing a structure of a network-based system for picking final recipients of joint-purchase goods through games according to an embodiment of the present invention.

As shown in FIG. 1, a communication network 100 is a communication network such as wire/wireless internet, and connects communication lines among plural user computers 200, plural goods provider computers 300, and a server computer 400 to communicate across the computers data related to joint purchases for goods to be jointly purchased.

The plural user computers 200 each log in new members for registration or members on request of a server computer 400 communication-connected through the communication network 100, outputs to the server computer 400 request data related to information on various goods registered at present for joint purchases and inputted by users logged in as the new members for registrations or the existing members, input from the server computer 400 information on plural goods for joint purchases including participation periods of time, the number of participants, joint-purchase payments, and participants status, and output to the server computer 400 joint-purchase request data on particular joint-purchase goods chosen by users who check information on plural goods for joint purchases.

Further, the plural user computers 200 input from the server computer 400 request data on payments according to joint purchases of specified goods, output to the server computer 400 data on payments according to joint purchases of corresponding goods inputted by users, communication-connect to the server computer 400 based on the manipulations of users participating in the joint purchases after the participation periods of time for joint purchases of goods expire or the number of participants established in advance is reached so as to participate in games for picking final recipients for joint-purchase goods.

The plural goods provider computers 300 output to the server computer 400 detailed information on various goods in stock and request goods sales, control the deliveries of joint-purchase goods based on final recipients inputted from the server computers 400, and output delivery result data to the server computer 400 and simultaneously bill and receive the cost based on the sales of specified goods.

The server computer 400 carries out the logs-in for new member registrations and members in the plural goods provider computers 300 communication-connected through the communication network 100, purchases goods with users' joint payments based on information on various goods requested for sales from the goods provider computers 300 and registers joint-purchase goods for which final recipients are picked through games, logs in new member registrations or members for the plural user computers 200 connected to the communication network 100, and outputs to the corresponding user computers 200 information on plural goods for joint purchases including participation periods of time, the number of participants, payments for joint purchases, participants status which are registered at present, according to the requests of the user computers 200.

Further, the server computer 400, if joint-purchase request data on particular joint-purchase goods is inputted from the user computers 200, requests payments for joint purchases of goods, processes the payments for corresponding joint purchases of goods based on the payment data, produces game matches for picking final recipients from all users participating in the joint purchases of corresponding goods if the participation periods of time expire or the number of participants established in advance is reached, processes games for winners of the user computers 200 connected through the communication network 100 until final recipients are picked based on the automatically produced game matches, outputs information on final recipients to the goods provider computers 300 if final recipients are picked with the game progresses, and orders deliveries of corresponding joint-purchase goods.

Further, if the server computer 400 identifies deliveries of joint-purchase goods to final recipients through particular goods provider computers 300, the server computer 400 deducts a certain amount of service charges from the payments of users participated in the joint purchases, provides the remaining amounts to the corresponding goods provider computers 300, and wraps up its services.

At this time, the server computer 400 provides game schedules(dates and times) for picking final recipients from all the user computers 200 participating in joint purchases of particular goods, and proceeds with games for choosing final recipients of particular joint-purchase goods collectively with the respective user computers 200 connected at designated times and dates. That is, the server computer 400 proceeds with games for picking final recipients only with the users connected at designated times and dates, and automatically eliminates users not connected at the designated times and dates to carry out smooth game progresses.

Further, the server computer 400 continuously proceeds with games for picking final recipients of particular joint-purchase goods in a one-to-one tournament fashion till the final recipients are selected.

Further, the server computer 400 can arbitrarily adjust the number of participants and joint payments of participants who want joint purchases of particular goods to raise or lower the possibilities for choosing final recipients.

For example, the server computer 400 registers a joint-purchase goods of as much as $1,280 in order that 128 users can jointly pay for and buy the joint-purchase goods, and, if 128 users apply for joint purchases of the corresponding goods with $10 each within a participation period of time, automatically produces game matches for picking a final recipient from the 128 users, proceeds with a tournament game for picking a final recipient with respect to the user computers 200 connected to the server computer 400 at designated time and date, and orders a delivery of the joint-purchase goods of the 128 users to a user if the corresponding user is finally selected.

Further, the server computer 400, if a game for selecting a final recipient is impossible with the insufficient participation number of users noticed in advance till the expiry of a participation period of time for the particular joint-purchase goods, determines either the extension of the participation period of time, the raise of the individual payments for the joint purchase, the cancellation of the joint purchase through the agreements of all the users participating in the particular joint-purchase goods.

In the meantime, in addition to the method wherein the server computer 400 registers as a joint-purchase goods a goods requested from the plural goods providers as described above in order for plural users to jointly buy the goods and controls a goods provider to deliver the joint-purchase goods to a final recipient if the final recipient is selected through a game, a method can be employed in which the server computer 400 directly secures and registers a goods as a joint-purchase goods in order for plural users to jointly buy the goods and delivers the joint-purchase goods to a final recipient selected through a game. That is, the server computer 400 can directly sell goods instead of selling goods provided by plural goods providers in the method presented by the present invention.

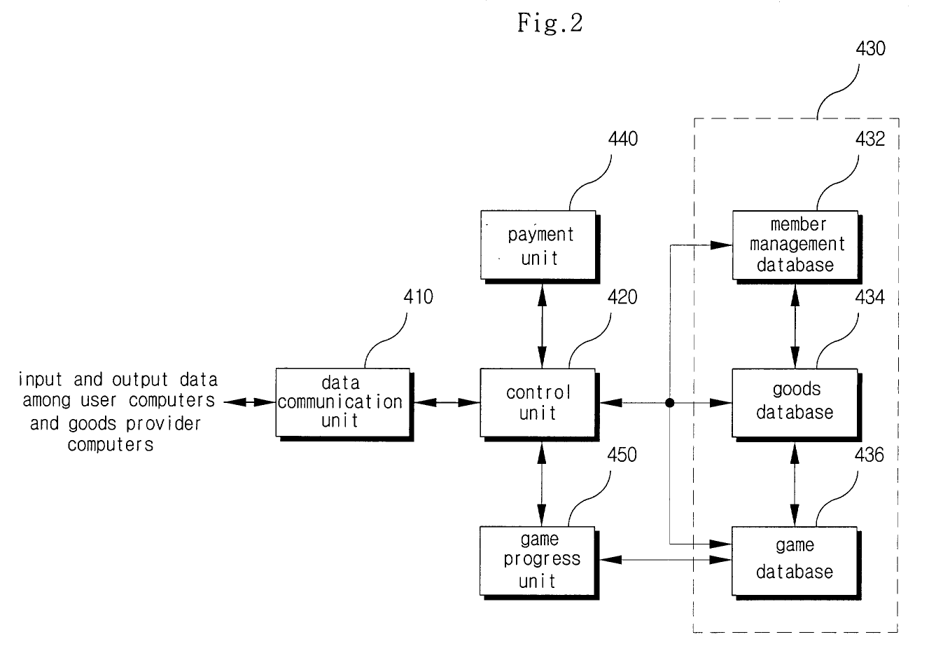

FIG. 2 is a block diagram for showing in detail a structure of the above server computer 400 of FIG. 1.

As shown in FIG. 2, a data communication unit 410 performs, together with plural goods provider computers 300 connected through the communication network 100, data inputs and outputs for new member registrations or members logs-in, inputs of information on a variety of goods to be requested for sales, and outputs of information on final recipients to receive goods, and carries out inputs and outputs for new member registrations or members logs-in together with plural user computers 200 connected through the communication network 100, outputs of information on plural joint-purchase goods registered at present, inputs of data on requests for joint purchases of particular goods, outputs of payment request data for joint purchases of corresponding goods, and inputs of payment data and outputs of game data for picking final recipients.

A control unit 420 performs connections for new member registrations or members based on data of new member registrations or members inputted from the goods provider computers 300 connected through the data communication unit 410, controls registrations for joint-purchase goods based on information on goods inputted from the goods provider computers 300, carries out connections for new member registrations or members based on new member registration or member logs-in data inputted from the connected user computers 200, and controls the corresponding user computers 200 to output information on plural joint-purchase goods registered in a database 430 at present based on requests of the user computers 200.

Further, the control unit 420 controls the outputs of payment request data for joint purchases of corresponding goods if data on joint-purchase requests of corresponding goods is inputted, outputs to a payment unit 440 payment data inputted from the user computers 200 through the data communication unit 410 and controls the payments for particular joint-purchase goods, controls game match generations for selecting final recipients from all users participating in joint purchases of particular goods through a game progress unit 450 if participation periods of time expire or the number of participants noticed in advance is reached, controls game progresses of all the user computers 200 participating in joint purchases of particular goods until final recipients are picked based on game schedules generated in the game progress unit 450, and controls outputting to the corresponding goods provider computers 300 information on final recipients of particular joint-purchase goods who are selected through game progresses of the game progress unit 450.

The database 430 includes a member management database 432 for storing logs-in information and personal information for users and goods providers registering members based on controls of the control unit 420, a goods database 434 for storing data on registrations of joint-purchase goods requested from the plural goods provider computers 300 based on controls of the control unit 420, and a game database 436 for storing information on users requested for joint-purchase goods item by item and information on final recipients based on game matches and game progresses for selecting final recipients.

The payment unit 440 generates and outputs to the control unit 420 information on payments of particular joint-purchase goods requested for purchases by users based on controls of the control unit 420, and settles payments of particular joint-purchase goods based on data on payments inputted from the control unit 420.

The game progress unit 450 stores predetermined game programs, for example, a rock paper scissor game and the like, for selecting final recipients, game matches are automatically generated based on controls of the control unit 420 to pick final recipients from all the users participating in joint purchases of particular goods, automatically generates game matches for picking final recipients from all users participating in joint purchases of particular goods based on controls of the control unit 420, proceeds with games by inputting and outputting game data together with all the user computers 200 participating in joint purchases of particular goods until final recipients are picked according to the automatically generated game matches, and outputs to the control unit 420 information on final recipients depending on game progresses.

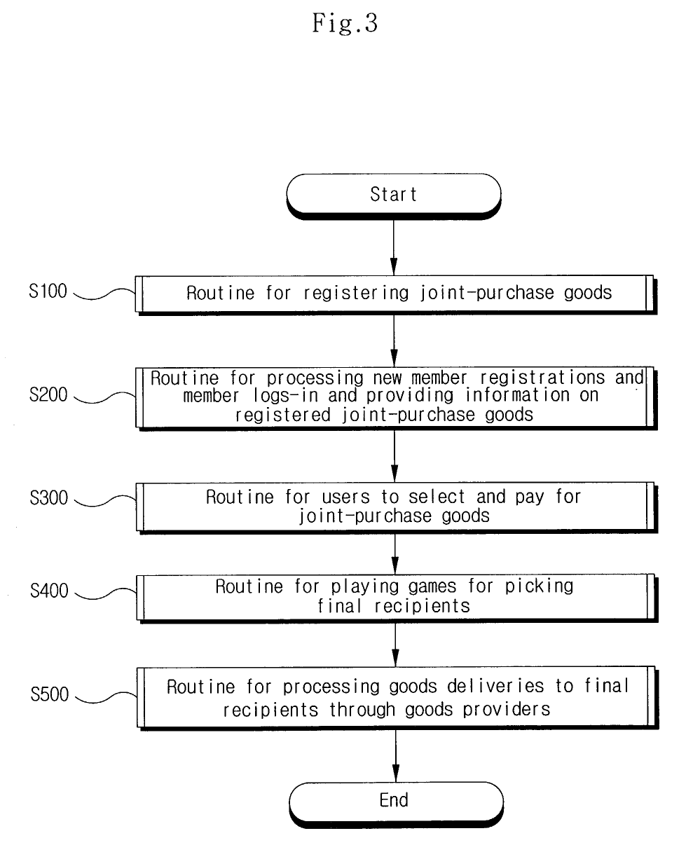

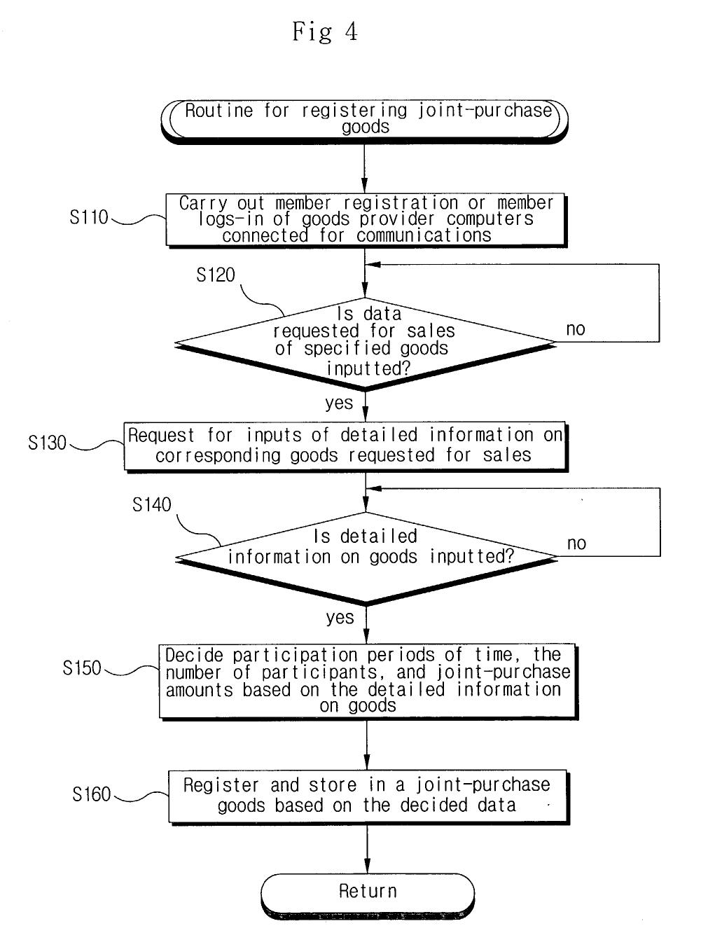

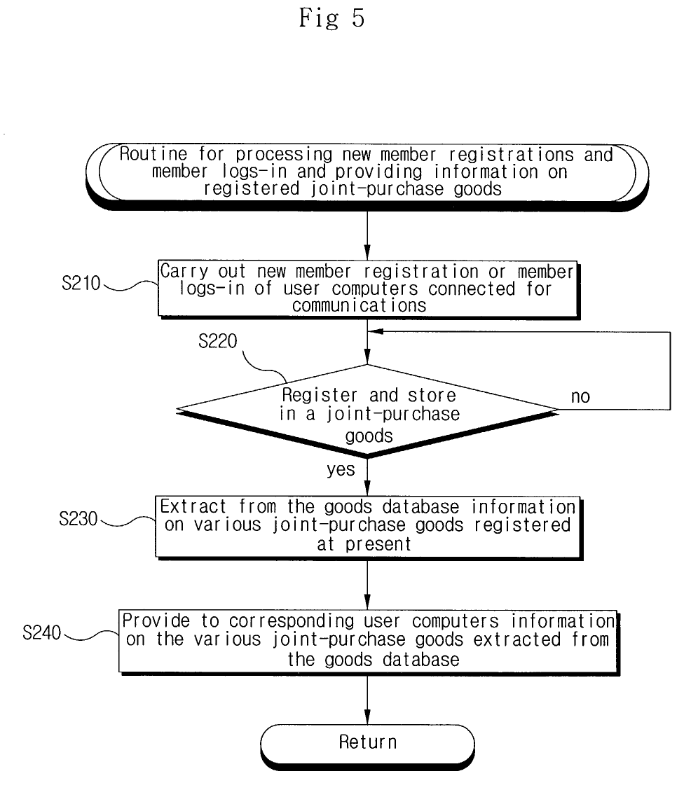

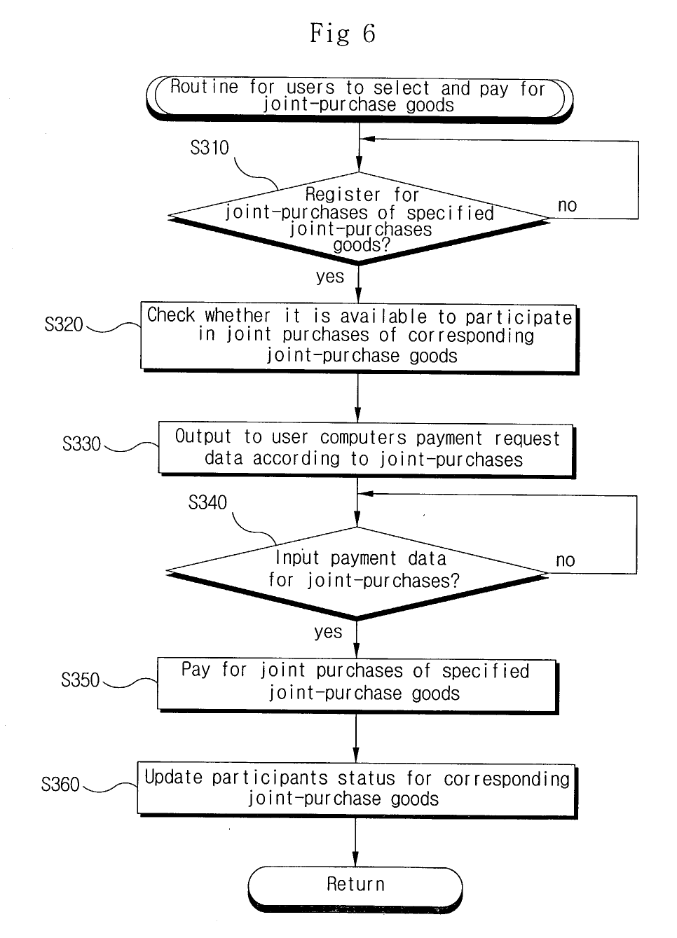

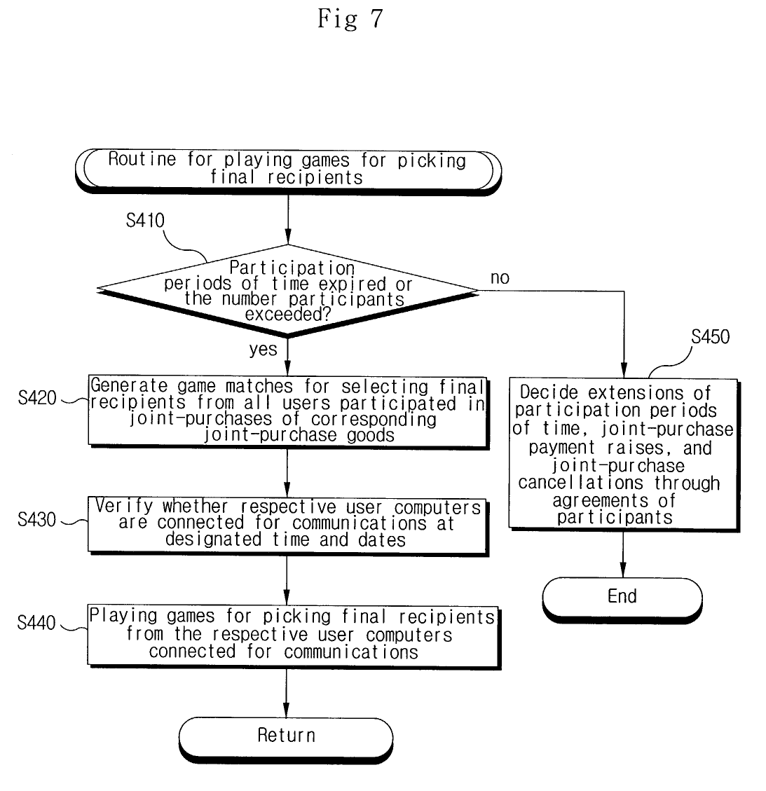

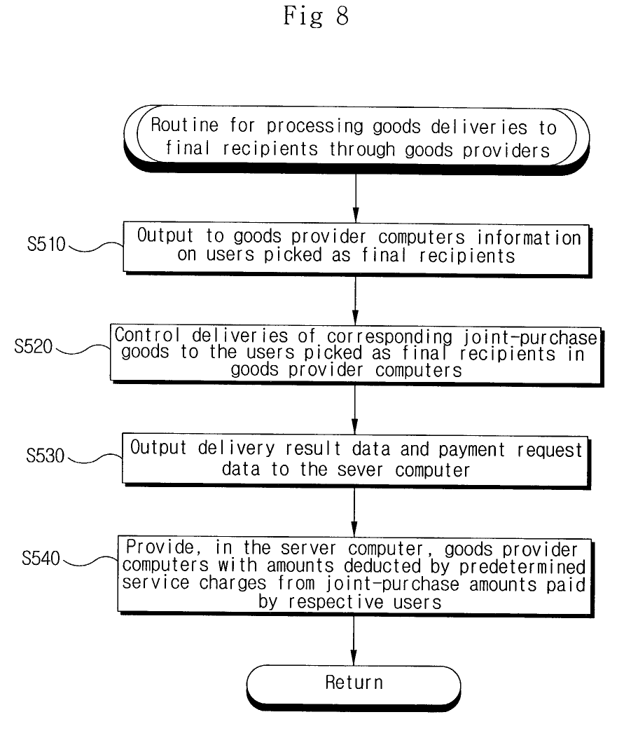

Next, a network-based method for picking final recipients of joint-purchase goods through games according to the present invention is described in detail with reference to FIG. 3 to FIG. 8.

FIG. 3 to FIG. 8 are flow charts for showing in detail operation procedures for a network-based method for picking final recipients of joint-purchase goods through games according to an embodiment of the present invention.

First of all, the server computer 400 purchases goods, with joint payments of users, based on information on a variety of goods inputted from the plural goods provider computers 300 connected through the communication network 100 and registers joint-purchase goods for a final recipient to be picked through a game(S100).

In detailed descriptions on the above, the server computer 400 carries out new member registrations or members logs-in of the plural goods provider computers 300 connected through the communication network 100(S110), and decides whether data requested for sales of particular goods in stock is inputted from the goods provider computers 300 which have carried out the new member registrations and member logs-in(S120).

As a result of the decision, if data requested for sales of particular goods is inputted from the goods provider computers 300, the server computer 400 requests an input of detailed information, for example, sale goods characteristics, price, delivery method, and so on, on corresponding goods requested for sales to the corresponding goods provider computers 300(S130), and decides whether the detailed information on the particular goods requested for sales is inputted from the corresponding goods provider computers 300(S140).

As a result of the decision, if the detailed information on the particular goods requested for sales from the corresponding goods provider computers 300 is inputted, the server computer 400 decides a participation period of time, the number of participants, payments for the registration of a joint-purchase goods according to a reference set in advance based on the detailed information on the corresponding item(S150).

Further, the server computer 400 registers and stores in the database 430 as a joint-purchase goods the particular goods requested from the goods provider computers 300 based on data on the participation period of time, the number of participants, and payments decided in the above step S150, and starts services(S160).

At this time, when, in the above step S100, the server computer 400 registers a joint-purchase goods based on the detailed information the goods provider offers, the operator of the server computer 400 adjusts the number of participants and payments of the users who jointly purchase the particular goods to raise or lower the odds for selecting a final recipient.

After registering the joint-purchase goods based on the requests of the respective goods providers through the above step S100, the server computer 400 logs in new members for registrations or members of the user computers 200 connected through the communication network 100, and outputs to the corresponding user computers 200 information on plural joint-purchase goods including participation periods of time, the number of participants, payments, and participants status which are registered in the database 430 at present(S200).

Describing it in detail, the server computer 400 logs in new member registration and members of the user computers 200 connected through the communication network 100(S210), and decides whether information on various joint-purchase goods is requested which is registered in the database 430 at present from the user computers 200 which have logged in the new member registrations or members(S220).

As a result of the decision, if information on the various joint-purchase goods which is registered at present is requested from the corresponding user computers 200, the server computer 400 extracts information on plural joint-purchase goods including participation periods of time, the number of participants, payments, and participants status which are stored in the goods database 434(S230), and outputs to the corresponding user computer 200 the information on the plural joint-purchase goods extracted from the goods database 434(S240).

As stated above, after providing the information on the various joint-purchase goods registered at present according to the requests of the respective users connected through the above step S200, the server computer 400 pays for the corresponding joint-purchase goods according to data on joint-purchase requests of the particular goods which are inputted from the user computers 200 that have identified the information on the plural joint-purchase goods, and updates and stores the participants status for the corresponding joint-purchase goods(S300).

Describing it in detail, the server computer 400 decides whether data on requests for the particular-joint purchase goods is inputted from the user computers 200 that have identified the information on the plural joint-purchase goods(S310).

As a result of the decision, if the data on requests for the particular joint-purchase goods is inputted from the corresponding user computers 200, the server computer 400 verifies whether it is available for the corresponding users to participate in the particular joint-purchase goods(S320), and generates and outputs to the corresponding user computers 200 payment request data based on the particular joint-purchase goods(S330).

Thereafter, the server computer 400 decides whether payments data based on the joint purchase of the particular goods is inputted from the corresponding user computers 200(S340), and, if payments data according to the joint purchase of the particular goods is inputted from the corresponding user computers 200, processes the payments according to the joint purchase of the particular goods based on the corresponding payment data(S350).

Further, after the server computer 400 pays for the particular joint-purchase item for the corresponding users, and updates and stores participants status for the corresponding joint-purchase goods(S360).

Now, the above step(S300) pays for the joint purchase for the users based on the joint-purchase requests of the particular goods, updates and stores participants status for the joint-purchase goods, and, if the participation period of time for the particular joint-purchase goods expires or the number of participants noticed in advance is reached, the server computer 400 automatically generates game matches for picking a final recipient from all the users participating in the joint purchase of the corresponding goods, and proceeds with a game for picking a final recipient of the respective user computers 200 connected through the communication network 100 based on the automatically generated game matches(S400).

Describing it in detail, the server computer 400 decides whether the ongoing participation period of time for a particular joint-purchase goods expires or the number of participants noticed in advance is reached(S410).

As a result of the decision, if the ongoing participation period of time for a particular joint-purchase goods expires or the number of participants noticed in advance is reached, the server computer 400 automatically generates game matches for picking a final recipient from all the users participating in the joint purchase of the corresponding goods(S420).

Thereafter, the server computer 400 verifies whether the respective user computers are connected which participate in the joint purchase of the particular is goods through the communication network 100 at a designated time and date(S430).

Further, the server computer 400 proceeds with a game for selecting a final recipient from the respective user computers 200 connected to the communication network 100 based on the game matches automatically generated through the above step S420(S440).

Further, as a result of the decision of the above step S410, if the number of participants noticed in advance is not reached till the ongoing participation period of time for the particular joint-purchase goods expires, the server computer 400 decides any one of the extension of the participation period of time, payment raises, and joint-purchase cancellations through the agreements of all the users participating in the joint purchase of the corresponding goods(S450).

At this time, the game running in the above step S400 to select a final recipient is collectively played with respect to all the user computers 200 which is connected at a designated time and date and participate in the joint purchase of a particular joint-purchase goods, and eliminates users who are not connected at the designated time and date, and the respective users play in a one-to-one tournament fashion the game for picking a final recipient.

As described above, after automatically generating game matches for picking a final recipient through the above step S400 and proceeding with a game for picking the final recipient from the respective users based on the automatically generated game matches, the server computer 400 outputs to the goods provider computers 300 the information on the final recipient picked with the progress of the game and controls delivering the corresponding joint-purchase goods to the final recipient(S500).

Describing it in detail, if the final recipient is decided as a result of the game run to select the final recipient of the respective user computers 200 participating in the particular joint-purchase goods through the above step S400, the server computer 400 outputs the information on the corresponding user selected as the final recipient to the goods provider computers 300(S510).

Thereafter, the corresponding goods provider computer 300 controls the delivery of the corresponding joint-purchase goods based on the information on the user selected as the final recipient of the particular joint-purchase goods inputted from the server computer 400(S520), and outputs to the server computer 400 data on the a delivery result of the particular joint-purchase goods delivered to the final recipient and payments data based on the sale of the corresponding goods(S530).

Thereafter, the server computer 400 verifies the data on the delivery result of the particular joint-purchase goods inputted from the corresponding goods provider computers 300, transfers to the corresponding goods provider computer 300 an amount deducted by a predetermined service charge from the joint-purchase amount paid by the respective users according to payments requests based on the sale of the particular joint-purchase goods, and ends the service(S540).

In the meantime, as in the description on the network-based method or above system for picking final recipients of joint-purchase goods through games according to the present invention, in addition to a method that registers as a joint-purchase goods the goods requested from plural goods providers in order for plural users to jointly pay the price for purchase and controls a goods provider to deliver the corresponding joint-purchase goods to a final recipient if the final recipient is picked through a game, a method can be use which the server computer 400 directly secures and registers goods as a joint-purchase goods in order for plural users to jointly pay the price for purchase and delivers the corresponding joint-purchase goods to a final recipient selected through a game.

As stated above, the network-based system and method for picking final recipients of joint-purchase goods through games can obtain opportunities acquiring at low prices goods purchased through joint payments of plural on-line users to greatly increase funs and interest in electronic commerce, and there is an effect in that goods retailers or service operators can greatly improve profits through electronic commerce activations due to inducing funs and interest of users.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A network-based system for picking final recipients of joint-purchase goods through games, comprising:
a communication network for connecting plural unspecified communication lines to communicate data therebetween;
plural user computers for inputting information on plural joint-purchase goods from a server computer connected through the communication network wherein the information further includes participation periods of time, the number of participants, joint-purchase amounts, and participants status, outputting to the server computer joint-purchase request data of specified goods selected by users who have identified information on plural joint-purchase goods, outputting to the server computer payment data of corresponding joint-purchase goods inputted by the users based on payment request of the server computer, and connecting for communications to the server computer according to users' manipulations and participating in games for picking final recipients of corresponding joint-purchase goods after participation periods of time for specified joint-purchase goods expire or the number of participants noticed in advance is reached;
plural goods provider computers for outputting to the server computer detailed information on various goods in stock for goods sales requests and controlling deliveries of corresponding joint-purchase goods based on information on the final recipients inputted from the server computer; and
the server computer for registering joint-purchase goods in order for users to jointly pay for purchases based on information on various goods requested for sales from the plural goods provider computers, outputting plural joint-purchase goods to the plural user computers connected for communications through the communication network wherein the information further includes participation periods of time, joint purchase amounts, and participants status, requesting for payments for joint purchases of goods if joint-purchase request data for corresponding goods is inputted from the user computers, paying for joint-purchase goods based on payment data inputted from the corresponding user computers, automatically generating game matches for picking final recipients from all users participating in joint-purchase goods if a participation periods of time expire or the number of participants noticed in advance is reached, proceeding with games for selecting winners of the respective user computers connected through the communication network till final recipients are picked based on the automatically generated game matches, and, if final recipients are selected according to game progresses, outputting information on corresponding final recipients to the goods provider computers and ordering deliveries of corresponding joint-purchase goods.

2. The network-based system as claimed in claim 1, wherein the server computer includes:
a data communication unit for inputting information on various goods to be requested for sales and outputting information on final recipients to whom goods is delivered with the plural goods provider computers connected for communications through the communication network, outputting information on plural joint-purchase goods registered at present, with the plural user computers connected for communications through the communication network, inputting joint-purchase request data for specified joint-purchase goods, outputting payment request data for joint purchases of corresponding goods, and inputting and outputting game data for selecting final recipients;
a control unit for registering joint-purchase goods based on information on goods inputted from the goods provider computers through the data communication unit, outputting information on plural joint-purchase goods registered at present to the user computers connected for communications, outputting payment request data for joint purchases of corresponding goods if request data on joint purchases of specified goods is inputted from the user computers through the data communication unit, outputting to a payment unit payment data inputted from the user computers through the data communication unit and controlling payments of specified joint-purchase goods, generating game matches for picking final recipients from all users participating in joint purchases of corresponding goods through a game progress unit if participation periods of time expire or the number of participants noticed in advance is reached, proceeding with games with respect to all users participating in joint purchases of specified goods till final recipients are selected based on game matches generated in the game progress unit, and outputting to the corresponding goods provider computers information on final recipients of specified joint-purchase goods picked through the game progress unit;
a database for storing logs-in information and personal information for users and respective goods providers that register members according to controls of the control unit, storing registration data for joint-purchase goods requested from the plural goods provider computers according to controls of the control unit, and storing information on respective users requesting for joint purchases item by item, game matches for picking final recipients, and information on final recipients based on game progresses; and
a payment unit for producing and outputting to the control unit information on payments for specified joint-purchase goods requested for purchases by users according to controls of the control unit, and paying for specified joint-purchase goods based on payment data inputted from the control unit; and
the game progress unit in which game programs are stored for selecting final recipients, for automatically producing game matches for picking final recipients from all users participating in joint purchases of specified goods according to controls of the control unit, inputting and outputting for game progresses game data with all the users computers participating in joint purchases of specified goods till final recipients are selected according to the automatically generated game matches, and outputting to the control unit information on final recipients selected according to game progresses.

3. The network-based system as claimed in claim 1, wherein the server computer provides schedules, for example, times and dates, for game progresses for selecting final recipients with respect to all the user computers participating in joint purchases of specified goods, collectively proceeding with games for picking final recipients of specified joint-purchase goods from the respective user computers connected for communications at designated times and dates, and eliminating users who are not connected for communications at the designated times and dates.

4. The network-based system as claimed in claim 1, wherein the server computer proceeds with games for selecting final recipients of specified joint-purchase goods in a one-to-one tournament fashion till final recipients are picked.

5. The network-based system as claimed in claim 1, wherein the server computer arbitrarily adjusts the participation number of users who jointly pay for specified joint-purchase goods and joint-purchase amounts to raise or lower odds for picking final recipients.

6. The network-based system as claimed in claim 1, wherein the server computer, if it is impossible to proceed with games for selecting final recipients due to insufficiency in the participation number of users for joint purchases which is noticed in advance till participation periods of time for specified joint-purchase goods expire, decides any one of extensions of the participation periods of time, joint-purchase amount raises, and joint-purchase cancellations through agreements of all users participating in joint purchases of corresponding goods.

7. A network-based system for picking final recipients of joint-purchase goods through games, comprising:
a communication network for connecting plural unspecified communication lines to communicate data therebetween;
plural user computers for inputting information on plural joint-purchase goods from a server computer connected through the communication network wherein the information further includes participation periods of time, the number of participants, joint-purchase amounts, and participants status, outputting to the server computer joint-purchase request data of specified goods selected by users who have identified the information on the plural joint-purchase goods, outputting to the server computer payments data of corresponding joint-purchase goods inputted by the users based on payment requests of the server computer, and connecting for communications to the server computer according to users' manipulations and participating in games for picking final recipients of corresponding joint-purchase goods after participation periods of time for specified joint-purchase goods expires or the number of participants noticed in advance is reached; and
the server computer for registering joint-purchase goods for which users jointly pay for purchases based on information on various goods in stock and pick final recipients through games, outputting information on plural joint-purchase goods to the plural user computers connected for communications through the communication network wherein the information further includes participation periods of time, joint-purchase amounts, and participants status, requesting for payments for joint-purchases of corresponding goods if joint-purchase request data for specified goods is inputted from the user computers, paying for the joint-purchase goods based on payment data inputted from corresponding user computers, automatically generating game matches for picking final recipients from all users participating in joint-purchase goods if participation periods of time expire or the number of participants noticed in advance is reached, proceeding with games for selecting winners of the respective user computers connected through the communication network till final recipients are picked based on the automatically generated game matches, and controlling deliveries of corresponding joint-purchase goods to final recipients according to game progresses.

8. A network-based method for picking final recipients of joint-purchase goods through games comprising steps of:
(1) registering, in a server computer, joint-purchase goods for which plural users jointly pay for purchases and select final recipients through games, based on information on various goods inputted from plural goods provider computers connected for communications through a communication network;
(2) carrying out, in the server computer, new member registrations or members logs-in of user computers connected for communications through the communication network, and outputting to corresponding user computers information on plural joint-purchase goods wherein the information further includes participation periods of time, the number of participants, joint-purchase amounts, and participants status which are registered in a database at present;
(3) paying for joint purchases of corresponding goods according to joint-purchase request data of specified goods inputted from the user computers which have identified information on plural joint-purchase goods, and updating and storing joint-purchase participants status of corresponding goods;
(4) automatically generating, in the server computer, game matches for selecting final recipients from all users participating in joint purchases of corresponding goods if participation periods of time for specified joint-purchase goods expire or the number of participants noticed in advance is reached, and proceeding with games for picking final recipients of the respective user computers connected for communications through the communication network based on the automatically generated game matches; and
(5) outputting information on final recipients selected based on game progresses from the server computer to the goods provider computers and controlling deliveries of corresponding joint-purchase goods to final recipients.

9. The network-based method as claimed in claim 8, wherein the step (1) includes steps of:
(1-1) carrying out, in the server computer, new member registrations or members logs-in of the goods provider computers connected for communications through the communication network;
(1-2) deciding in the server computer whether data requesting for sales of specified goods is inputted from the goods provider computers which have carried out the new member registrations or members logs-in;
(1-3) requesting for inputs of detailed information on corresponding goods requested for sales from the server computer to corresponding goods provider computers if the data requesting for sales of the specified goods is inputted from the corresponding goods provider computers as a result of the decision;
(1-4) deciding in the server computer whether the detailed information on the specified goods requested for sales is inputted from the corresponding goods provider computers;
(1-5) deciding, if the detailed information on the specified goods requested for sales is inputted from the corresponding goods provider computers as a result of the decision, in the server computer, participation periods of time, the number of participants, and joint-purchase amounts for registering joint-purchase goods according to references set in advance based on the detailed information of the corresponding goods; and
(1-6) registering, in the server computer, as joint-purchase goods and storing in a database the specified goods requested from the goods provider computers based on data of the participation periods of time, the number of participants, and joint-purchase amounts decided in the step (1-5).

10. The network-based method as claimed in claim 8, wherein the step (2) includes steps of:
(2-1) carrying out, in the server computer, new member registrations or members logs-in of the user computers connected for communications through the communication network;
(2-2) deciding, in the server computer, whether information on various joint-purchase goods registered at present is requested from the user computers which have carried out the new member registrations or member logs-in;
(2-3) extracting, if the information on the various joint-purchase goods registered at present is requested from the user computers as a result of the decision, in the server computer, information on plural joint-purchase goods including participation periods of time, the number of participants, joint-purchase amounts, and participants status which are stored in the goods database; and
(2-4) outputting, from the server computer to the corresponding user computers, the information on the plural joint-purchase goods including the participation periods of time, the number of participants, joint-purchase amounts, and participants status which are extracted from the goods database.

11. The network-based method as claimed in claim 8, wherein the step (3) includes steps of:
(3-1) deciding in the server computer whether joint-purchase request data for specified joint-purchase goods is inputted from the user computers which identify information on plural joint-purchase goods;
(3-2) checking in the server computer whether corresponding users are available for joint-purchase participations for the specified joint-purchase goods, if the joint-purchase request data for the specified joint-purchase goods is inputted from the user computers as a result of the decision;
(3-3) producing and outputting, from the server computer to corresponding user computers, payment request data based on the joint purchases of the specified joint-purchase goods;
(3-4) deciding in the server computer whether the payment data based on the joint purchases of the specified joint-purchase goods is inputted from the corresponding user computers;
(3-5) processing, if the payment data based on joint purchases of the specified joint-purchase goods is inputted from the corresponding user computers as a result of the decision, in the server computer, the payments according to the joint purchases of the specified joint-purchase goods based on the payment data inputted from the user computers; and
(3-6) updating and storing, in the server computer, the participants status of the corresponding joint-purchase goods after the payments for the joint-purchases of the specified joint-purchase goods of the corresponding users.

12. The network-based method as claimed in claim 8, wherein the step(4) includes steps of:
(4-1) deciding in the server computer whether ongoing participation periods of time for the specified joint-purchase goods expire or the number of participants noticed in advance is reached;
(4-2) automatically generating, if the ongoing participation periods of time for the specified joint-purchase goods expire or the number of participants noticed in advance is reached, in the server computer, game matches for picking final recipients from all the users participating in joint purchases of corresponding joint-purchase goods;
(4-3) verifying in the server computer whether respective user computers participating in joint purchases of the specified goods are connected for communications through the communication network at designated times and dates; and
(4-4) proceeding, in the server computer, with games for picking final recipients from the respective user computers connected for communication through the communication network based on the game matches automatically generated through the step(4-2).

13. The network-based method as claimed in claim 12, wherein, if the number of participants noticed in advance is not reached till the ongoing participation periods of time for specified joint-purchase goods expire as a result of the decision of the step(4-1), the step(4) further includes a step (4-5) for deciding any one of extensions of participation periods of time, joint-purchase amount raises, and joint-purchase cancellations through agreements of all users participating in joint purchases of corresponding joint-purchase goods.

14. The network-based method as claimed in claim 8, wherein the step(5) includes steps of:
(5-1) outputting, if final recipients are decided as a result of games for picking final recipients in the respective user computers participating in joint purchases of specified goods through the step(4), information on corresponding users picked as the final recipients from the server computer to the goods provider computers requested for sales of the joint-purchase goods;
(5-2) controlling in the corresponding goods provider computers deliveries of the corresponding joint-purchase goods based on information on users picked as the final recipients of the specified joint-purchase goods inputted from the server computer;
(5-3) outputting, from the goods provider computers to the server computer, data on delivery results of the specified joint-purchase goods delivered to the final recipients and payment request data according to sales of the corresponding goods; and
(5-4) paying, in the server computer, to the corresponding goods provider computers amounts deducted by predetermined service charges from joint-purchase amounts paid by respective users according to the sales of the specified joint-purchase goods and ending services.

15. The network based method as claimed in claim 8, wherein, when registering joint-purchase goods based on detailed information that goods providers offer in the step(1), a server computer operator arbitrarily adjusts the number of participants and joint-purchase amounts for users who jointly pay for and purchase specified goods to raise or lower the odds for selecting final recipients.

16. The network-based method as claimed in claim 8, wherein games proceeded in the step(4) to pick final recipients are collectively played for all the user computers who participates in joint purchases of the specified goods and are connected for communications at designated times and dates, and the users failed in communication connections at the designated times and dates are processed disqualified.

17. The network-based method as claimed in claim 8, wherein game matches generated in the step(4) to pick final recipients are one-to-one tournament game matches.

18. The network-based method for picking final recipients of joint-purchase goods through games comprising steps of:
(A) registering joint-purchase goods for which users jointly pay for purchases based on information on various goods the server computer holds and select final recipients through games;
(B) carrying out, in the server computer, new member registrations and members logs-in of the user computers connected for communications through the communication network, and outputting to corresponding user computers information on plural joint-purchase goods wherein the information further includes participation periods of time, the number of participants, joint-purchase amounts, and participants status registered in the database at present;
(C) paying, in the server computer, for joint-purchases of corresponding goods according to joint-purchase request data of specified joint-purchase goods inputted from the user computers which have identified information on plural joint-purchase goods, and updating and storing participants status for corresponding joint-purchase goods;
(D) automatically generating, in the server computer, game matches for picking final recipients from all users participating in joint-purchases of corresponding goods if the participation periods of time for specified joint-purchase goods expire or the number of participants noticed in advance is reached, and proceeding with games for selecting based on the automatically generated game matches final recipients of the respective user computers connected through the communication network; and
(E) controlling, in the server computer, deliveries of corresponding joint-purchase goods to final recipients based on information on the final recipients picked with game progresses.
